(19) United States
(12) Patent Application Publication
(10) Pub. No.: US 2025/0187421 A1
(43) Pub. Date: Jun. 12, 2025

(54) MOTOR VEHICLE WITH SUPPORTING STRUCTURE AND HIGH-VOLTAGE BATTERY

(71) Applicant: MAGNA STEYR Fahrzeugtechnik GmbH & Co KG, Graz (AT)

(72) Inventors: Christian LIENHART, Seiersberg (AT); Werner SCHWARZL, Laßnitzhoehe (AT)

(73) Assignee: MAGNA STEYR Fahrzeugtechnik GmbH & Co KG, Graz (AT)

(21) Appl. No.: 18/928,855

(22) Filed: Oct. 28, 2024

(30) Foreign Application Priority Data
Dec. 7, 2023 (EP) 23214908.8

(51) Int. Cl. B60K 1/04; B62D 25/20; H01M 50/204; H01M 50/242; H01M 50/249; H01M 50/262; H01M 50/289

(52) U.S. Cl. CPC B60K 1/04; B62D 25/20; H01M 50/204; H01M 50/242; H01M 50/249; H01M 50/262; H01M 50/289; B60K 2001/0438; H01M 2220/20

(57) ABSTRACT

A motor vehicle, and a method for producing a motor vehicle. The motor vehicle includes a load-bearing structure having at least two longitudinal members, and a battery that includes a single-piece battery frame that laterally delimits the battery to form at least radially internal portions of the at least two longitudinal members, a support plate that forms a base which covers an underside of the battery frame, and a plurality of battery cells arranged in the battery frame and fastened on the support plate.

### CROSS-REFERENCE TO RELATED APPLICATIONS

The present application claims priority under 35 U.S.C. § 119 to European Patent Publication No. EP23214908.8 (filed on Dec. 7, 2023), which is hereby incorporated by reference in its complete entirety.

### TECHNICAL FIELD

The present disclosure relates to a motor vehicle comprising a load-bearing structure and comprising a high-voltage battery and to a method for producing such a motor vehicle.

### BACKGROUND

It is known that closed high-voltage batteries can be installed in motor vehicles, in particular as a traction battery for supplying electrical energy for the propulsion of the motor vehicle. The battery then has a closed battery box or a closed battery housing which accommodates the cell modules. Such a high-voltage battery is fastened to the vehicle via a screw connection. Apart from at the screw points, a gap is usually present here between the battery and the vehicle structure of at least a few millimetres so that rubbing during operation (noise, corrosion, etc.) is avoided but also in order to enable collision-free assembly. The whole battery has to be disassembled from the vehicle for maintenance or repair.

Battery housings can here use battery frames which include a plurality of individual parts and are installed adjacent to cross-members, an underride protector and a battery cover. The battery housing is fastened in the underfloor and can be disassembled. The sealing of the vehicle body is ensured by corresponding components in the floor assembly and is independent of the battery housing.

### SUMMARY

An object of the present disclosure is to provide a motor vehicle having a load-bearing structure and a high-voltage battery which has low structural space requirements, a low weight and low production costs. A further object is to provide a simple and cost-effective method for assembling the high-voltage battery in such a motor vehicle.

The object is achieved by a motor vehicle comprising a load-bearing structure, wherein the load-bearing structure comprises at least two longitudinal members, moreover comprising a high-voltage battery, wherein the high-voltage battery comprises a frame delimiting the high-voltage battery laterally, wherein a plurality of battery cells are arranged in the frame, wherein the frame is designed as a single piece, wherein at least radially internal portions of the longitudinal members are formed by the one-piece frame, wherein a support plate forms the base, covering the frame at its underside, of the high-voltage battery, wherein the battery cells are fastened on the support plate.

According to the present disclosure, a high-voltage battery uses as a battery housing a one-piece frame which not only is fastened to the longitudinal members but also forms portions of the longitudinal members. In addition, the battery housing uses a support plate with battery cells fastened thereon as the base of the battery housing. By virtue of this structure, on the one hand the structural space requirement of the high-voltage battery is reduced. With the same structural space, the room available in the high-voltage battery can be enlarged and can be used for more battery capacity. This results in a reduced number of components and reduced costs and weight. Simplified production of a motor vehicle is made possible as a result. The support plate can be equipped with battery cells independently of the load-bearing structure and the remainder of the motor vehicle and this pre-assembled subassembly can be fastened to a frame joined to the remainder of the motor vehicle.

Developments of the present disclosure are provided in the dependent claims, the description and the attached drawings.

The support plate is preferably fastened in sealing fashion to the frame, preferably via a sealing element and a screw connection.

The underside of the support plate preferably forms an underride protection plate of the motor vehicle. As a result, even more structural space is saved, namely in the Z direction of the vehicle.

A floor panel of the motor vehicle closing the interior of the motor vehicle at the bottom preferably forms the cover, covering the frame on its top side, of the high-voltage battery. The battery housing is then formed by the frame, the support plate (as the base) and the floor panel (as the cover).

The frame preferably forms a flange at at least one portion at the lower end of the frame. The frame is fastened by the flange to another motor vehicle component, in particular to a further longitudinal member component. The frame particularly preferably forms a flange at the lower end of the frame at at least one side region in which a radially internal portion of the longitudinal member is formed by the frame. In particular, essentially the whole frame can form a flange at the lower end of the frame.

The flange is preferably arranged laterally next to the fastening of the support plate to the frame, particularly preferably laterally next to the sealing element and the screw connection.

The flange is preferably formed so that it runs downwards obliquely outwards. As a result, it is simpler to insert the support plate, preferably with battery cells assembled thereon, into the frame subsequently and from below and to fasten it to the frame.

B cross-members are preferably fastened to the cover of the high-voltage battery.

At least radially internal portions of at least one cross member, preferably two cross-members, are preferably formed by the one-piece frame. The portions of cross-members preferably form the portions of the frame which are situated at the front and rear of the motor vehicle, and the portions of longitudinal members form the portions of the frame which are situated on the left and right of the motor vehicle.

The battery cells are preferably inserted into the support plate directly, preferably as individual battery cells. The support plate particularly preferably forms pockets which are open at the top and into which the battery cells are inserted.

A method for producing a motor vehicle, as described above, can provide that the battery cells are fastened on the support plate, and that, independently of the assembly of the battery cells on the support plate, the frame is assembled on another motor vehicle component, in particular on a further longitudinal member component. The support plate with the fastened battery cells is then introduced from below into the frame which is already assembled on another motor vehicle component, in particular on a further longitudinal member component, and fastened to this frame.

### DRAWINGS

One or more embodiments of the present disclosure will be illustrated by way of example in the drawings and explained in the description hereinbelow.

FIG. 1 is a partial sectional view of a motor vehicle according to the present disclosure with a line of section in the X-direction of the motor vehicle.

FIG. 2 is a partial sectional view of a motor vehicle according to the present disclosure with a line of section in the Y-direction of the motor vehicle.

FIG. 3 is a partial sectional view of an alternative motor vehicle according to the present disclosure with a line of section in the Y-direction of the motor vehicle.

### DESCRIPTION

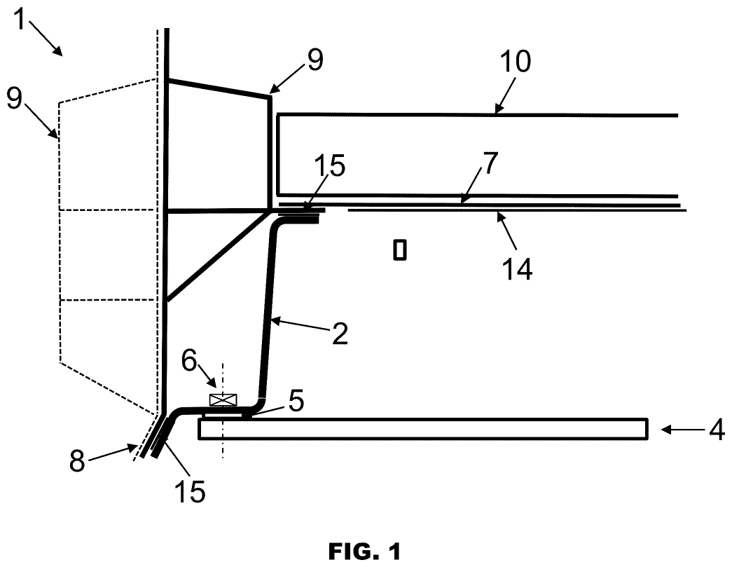

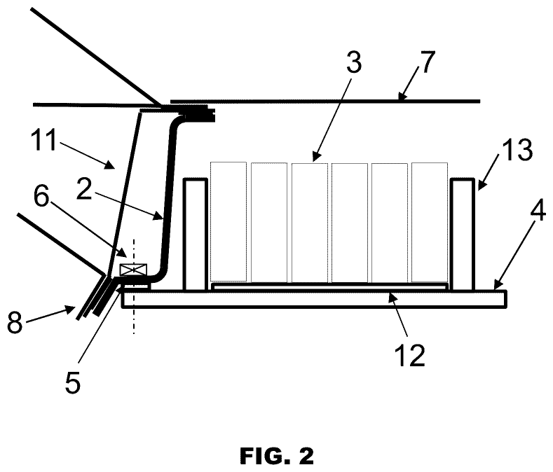

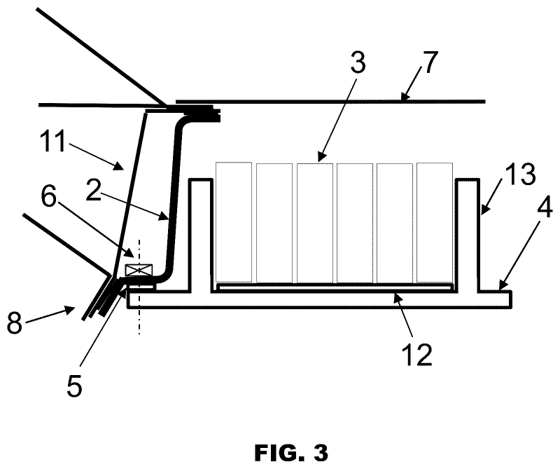

Illustrated in FIG. 1 is a detail of a motor vehicle according to the present disclosure, in the vicinity of a longitudinal member 1, i.e. a sill, formed from the components the frame 2 and further longitudinal member components 9, wherein the illustration in section is made with a line of section in the X direction of the vehicle, i.e. in a plane which is perpendicular to the X axis of the motor vehicle. FIGS. 2 and 3 show alternative embodiments of a motor vehicle according to the present disclosure with a line of section in the Y direction of the vehicle, i.e. in a plane which is perpendicular to the Y axis of the motor vehicle.

As illustrated in FIG. 1, the motor vehicle comprises a load-bearing structure that comprises at least two longitudinal members 1. Moreover, the motor vehicle comprises a high-voltage battery comprising an annular frame 2 delimiting the high-voltage battery laterally. The annular frame 2 is designed as single piece. Radially internal portions of the longitudinal members 1, i.e., the sills, are formed by the one-piece annular frame 2, namely portions of the longitudinal member 1 situated internally and at the bottom. Portions situated internally at the top and external portions of the sill are formed by further longitudinal member components 9.

The annular frame 2 forms the lateral delimitation of the battery housing of the high-voltage battery. The annular frame 2 can be formed from steel. A support plate 4 forms the base, covering an underside of the annular frame 2, of the high-voltage battery and thus the base of the battery housing. The battery cells 3 are fastened on the support plate 4, preferably as individual cells, as illustrated in FIGS. 2 and 3. The battery cells 3 can be assembled so that they stand on the support plate 4. A cooling plate 12 can be arranged between the support plate 4 and the battery cells 3. The battery cells 3 are arranged in the annular frame 2. The underside of the support plate 4 forms an underride protection plate of the motor vehicle.

A floor panel 7 of the motor vehicle closing the interior of the motor vehicle at the bottom forms the cover which covers the annular frame 2 on a top side of the high-voltage battery. A fire-protection element 14 can be arranged between the battery cells 3 and the cover, i.e., the floor panel 7. B cross-members 10 are fastened directly to the cover of the high-voltage battery.

The support plate 4 can have protruding strips 13 which preferably run in the Y-direction and between which the battery cells 3 are arranged. The support plate 4 can have a multi-part design such that, for example, the strips 13 are joined to a base plate, as illustrated in FIG. 2. The support plate 4 can have a single-part design, as illustrated in FIG. 3, and can preferably be formed by a cast component.

The support plate 4 is fastened in sealing fashion to the annular frame 2, namely via a sealing element 5, preferably an EPDM (ethylene propylene diene monomer rubber) seal and via a screw connection 6. The screw connection 6 of the support plate 4 to the housing, namely to the annular frame 2, can be disassembled.

The annular frame 2 forms a flange 8 at the lower end of the frame, wherein the frame is fastened by the flange 8 to another motor vehicle component, namely to a further longitudinal member component 9, preferably via adhesive 15 and self-piercing rivets. The annular frame 2 can additionally be fastened to another motor vehicle component, preferably to a further longitudinal member component 9, outside the flange 8, in particular at the upper end of the annular frame 2, for example via adhesive 15 and self-piercing rivets, as illustrated in FIG. 1.

The flange 8 is arranged laterally next to the fastening of the support plate 4 to the annular frame 2, namely laterally next to the sealing element 5 and the screw connection 6. The flange 8 is formed so that it runs downwards obliquely outwards. The flange is preferably inclined by approximately 20 to 40 degrees, preferably by approximately 30 degrees. Introducing the support plate 4 into the frame 2 from below is facilitated as a result.

As shown in FIGS. 2 and 3, radially internal portions of cross-members 11 can be formed by the one-piece annular frame 2, in particular of a cross member 11 situated at the front of the annular frame 2 and one situated at the rear of the annular frame 2.

In a method for producing a motor vehicle as illustrated in FIGS. 1 to 3, the battery cells 3 are fastened on the support plate 4 and, independently thereof, for example at another location, the annular frame 2 is assembled on another motor vehicle component, in particular on a further longitudinal member component 9. The support plate 4 with the fastened battery cells 3 is then fastened from below to the annular frame 2 already assembled to another motor vehicle component, in particular to a further longitudinal member component 9.

The present disclosure thus describes the integration of a high-voltage battery, produced from a one-part circumferential ring, namely the annular frame 2, which is integrated into the floor assembly from below and is closed from below with a support plate 4 which is equipped with battery cells, and thus forms a battery.

In this construction method, a one-part circumferential steel ring, the frame 2, is joined fixedly to the body shell from below. The one-part ring on the one hand replaces the sill on the inside at the bottom and at the same time constitutes the battery housing.

This ring is introduced into the underfloor subassembly as the last element, which requires the lower sill flange, the flange 8, to be inclined in order not to shear off the adhesive 16, on the one hand, and makes it possible to centre the component, on the other hand.

The resulting cavity serves as structural space for a traction battery and is closed from below via the disassembled support plate 4. The support plate 4 for the battery cells 3 can be formed of a multi-part welded construction and in an alternative embodiment can also be produced as a one-part cast component. The support plate 4 forms upward-facing pockets into which the battery cells 3 can be inserted directly without having to be combined first as modules. The support plate 4 is preferably pre-mounted in the disassembled state at a supplier and the battery is delivered, secured with a high-voltage cover. First, the cooling plates 12 are laid inside the support plate 4 and then the cells 3 are inserted into the support plate 4 from above and electrically connected to one another. For protection, the support plate 4 and the housing are screwed to each other via a screw connection 6.

An essential advantage of this arrangement is the gain in structural space in the Y-direction by the amount that the cross section of the battery frame usually requires, and the integration of a plurality of components and the associated saving in costs and weight.

A modular construction method of the battery cells 3 can, in this construction method, be replaced simply by a cell-to-pack arrangement, as a result of which a higher energy density can be achieved with the same structural space.

The Z-dimensional chain also becomes smaller because of the lack of an air gap between the floor plate and the battery housing.

### LIST OF REFERENCE SYMBOLS

1 longitudinal member
2 frame
3 battery cells
4 support plate
5 sealing element
6 screw connection
7 floor panel
8 flange
9 further longitudinal member component
10 B cross-member
11 cross-member
12 cooling plate
13 strips
14 fire-protection element
15 adhesive

What is claimed is:

1. A motor vehicle, comprising:
a load-bearing structure having at least two longitudinal members; and
a battery that includes a single-piece battery frame that laterally delimits the battery to form at least radially internal portions of the at least two longitudinal members, a support plate that forms a base which covers an underside of the battery frame, and a plurality of battery cells arranged in the battery frame and fastened on the support plate.

2. The motor vehicle of claim 1, wherein the support plate is fastened in sealing fashion to the battery frame via a sealing element and a screw connection.

3. The motor vehicle of claim 1, wherein an underside of the support plate forms an underride protection plate of the motor vehicle.

4. The motor vehicle of claim 1, wherein the support plate forms a floor panel of the motor vehicle which closes an interior of the motor vehicle.

5. The motor vehicle of claim 1, wherein:
at least one portion of a lower region of the battery frame forms a flange, and
the flange facilitates fastening of the battery frame to a second longitudinal member.

6. The motor vehicle of claim 5, wherein:
the support plate is fastened in sealing fashion to the battery frame via a sealing element and a screw connection, and
the flange is arranged laterally adjacent to a fastening region of the support plate to the frame.

7. The motor vehicle of claim 5, wherein the flange extends obliquely outwardly in a downward direction.

8. The motor vehicle of claim 1, further comprising cross-members fastened to the support plate.

9. The motor vehicle of claim 8, wherein the battery frame forms radially internal portions of the cross-members.

10. The motor vehicle of claim 1, wherein the support plate comprises upward-facing pockets into which the battery cells are inserted.

11. The motor vehicle of claim 1, wherein the battery comprises a high-voltage battery.

12. A motor vehicle, comprising:
longitudinal members forming a load-bearing structure; and
a battery that includes a battery housing comprising a single-piece battery frame that delimits the battery laterally to form at least radially internal portions of the longitudinal members, a support plate arranged under the battery frame, and a plurality of battery cells arranged in the battery frame and fastened on the support plate.

13. The motor vehicle of claim 12, wherein the support plate is fastened to the battery frame via a sealing element and a screw connection.

14. The motor vehicle of claim 12, wherein an underside of the support plate forms an underride protection plate of the motor vehicle.

15. The motor vehicle of claim 12, wherein the support plate forms a floor panel of the motor vehicle which closes an interior of the motor vehicle.

16. The motor vehicle of claim 12, wherein:
at least one portion of a lower region of the battery frame forms a flange, and
the flange facilitates fastening of the battery frame to a second longitudinal member.

17. The motor vehicle of claim 12, further comprising cross-members fastened to the support plate.

18. The motor vehicle of claim 17, wherein the battery frame forms radially internal portions of the cross-members.

19. The motor vehicle of claim 1, wherein the support plate comprises upward-facing pockets into which the battery cells are inserted.

20. A method for producing a motor vehicle, the method comprising:
forming a load-bearing structure via first longitudinal members;
forming a battery housing comprising a single-piece battery frame that forms at least radially internal portions of the longitudinal members,
fastening a plurality of battery cells on the support plate;
fastening the battery frame to a second longitudinal member; and
fastening the support plate with the fastened battery cells to a lower region of the battery frame.
